(19) United States
(12) Patent Application Publication
(10) Pub. No.: US 2020/0159646 A1
(43) Pub. Date: May 21, 2020

(54) INFORMATION PROCESSING APPARATUS

(71) Applicant: FUJITSU LIMITED, Kawasaki-shi (JP)

(72) Inventor: TAKUYA FUJII, Kawasaki (JP)

(73) Assignee: FUJITSU LIMITED, Kawasaki-shi (JP)

(21) Appl. No.: 16/667,943

(22) Filed: Oct. 30, 2019

(30) Foreign Application Priority Data
Nov. 16, 2018 (JP) 2018-215918

(51) Int. Cl. G06F 11/36; G06F 11/28; G06F 11/34

(52) U.S. Cl. CPC G06F 11/3644; G06F 11/3476; G06F 11/3636; G06F 11/28

(57) ABSTRACT

An information processing apparatus is configured to execute a monitor program with a first amount of log information to be output during an execution of the program, detect an occurrence of a failure while the program is being executed with the first amount, change an amount of the log information from the first amount to a second amount larger than the first amount when the occurrence is detected while the program is being executed with the first amount, execute the program with the second amount, change the amount from the second amount to a third amount smaller than the second amount when the occurrence is not detected while the program is being executed with the second amount, execute the program with the third amount, and analyze the log information when the occurrence is detected while the program is being executed with the second amount or executed with the third amount.

### CROSS-REFERENCE TO RELATED APPLICATION

This application is based upon and claims the benefit of the prior Japanese Patent Application No. 2018-215918, filed on Nov. 16, 2018, the entire contents of which are incorporated herein by reference.

### FIELD

The embodiments discussed herein are related to an information processing apparatus.

### BACKGROUND

Prior to the operation of an information processing apparatus (computer), a POST (Power-On Self-Test) is typically performed by a BIOS (Basic Input/Output System). The POST is performed by executing a POST program, which is a test program, when the BIOS is booted, and includes a process of detecting and initializing each component in the information processing apparatus.

There is known a restart control system that automatically restarts an information processing apparatus when a failure occurs in the information processing apparatus (see, e.g., Japanese Laid-open Patent Publication No. 07-168729). There is also known a dynamic single clock trace method in a logic device operating in synchronization with a clock (see, e.g., Japanese Laid-open Patent Publication No. 01-131934).

Related techniques are disclosed in, for example, Japanese Laid-open Patent Publication Nos. 07-168729 and 01-131934.

### SUMMARY

According to an aspect of the embodiments, an information processing apparatus includes a memory in which a monitor program is stored, and a processor coupled to the memory and configured to execute the monitor program with a first amount of log information to be output during an execution of the monitor program, detect an occurrence of a failure while the monitor program is being executed with the first amount, change an amount of the log information from the first amount to a second amount larger than the first amount when the occurrence of the failure is detected while the monitor program is being executed with the first amount, execute the monitor program with the second amount, change the amount of the log information from the second amount to a third amount smaller than the second amount when the occurrence of the failure is not detected while the monitor program is being executed with the second amount, execute the monitor program with the third amount, and analyze the log information when the occurrence of the failure is detected while the monitor program is being executed with the second amount or executed with the third amount.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a CPU (central processing unit) and a BMC (baseboard management controller);

FIG. 2 is a flowchart of suspicious location identification operation;

FIG. 3 is a flowchart of investigation operation;

FIG. 4 is a view illustrating a BIOS log;

FIG. 5 is a functional configuration diagram of an information processing apparatus;

FIG. 6 is a flowchart of a control process;

FIG. 7 is a hardware configuration diagram of the information processing apparatus;

FIG. 8 is a hardware configuration diagram of a BMC;

FIG. 9 is a functional configuration diagram of a CPU;

FIG. 10 is a functional configuration diagram of a BMC;

FIG. 11 is a view illustrating a BIOS log having a diagnosis level of 1,

FIG. 12 is a view illustrating a BIOS log having a diagnosis level of MAX;

FIG. 13 is a flowchart of a switching control process;

FIG. 14 is a view illustrating a thinned-out BIOS log;

FIG. 15 is a flowchart of a hang-up location analysis process;

FIG. 16 is a flowchart of a switching process;

FIG. 17 is a flowchart of a log analysis process;

FIG. 18 is a flowchart of a log adjustment process;

FIG. 19 is a flowchart of a diagnosis start level setting process; and

FIG. 20 is a flowchart of an analysis operation.

### DESCRIPTION OF EMBODIMENTS

When the POST program hangs up at the time of booting the BIOS, a suspicious location of failure occurrence is identified by analyzing the BIOS log output during the execution of the POST program. However, when the BIOS log is insufficient, the identification accuracy of the suspicious location is lowered. Without being limited to a case when analyzing the BIOS log output during the execution of the POST program, even when analyzing a log output during the execution of other programs, the identification accuracy of the suspicious location is lowered when the log is insufficient.

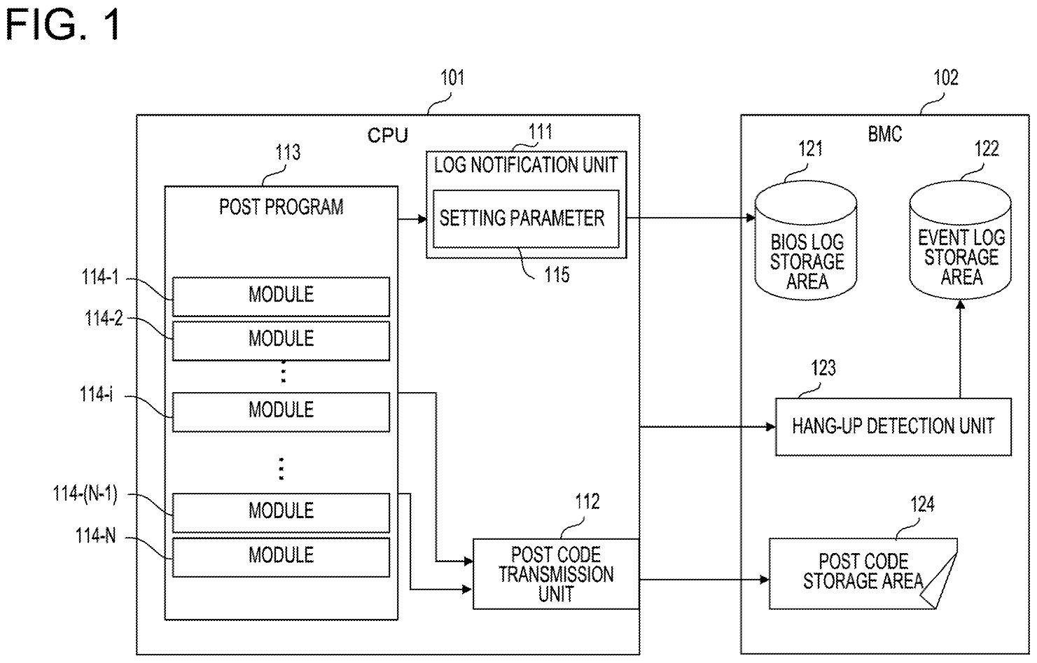

Hereinafter, an embodiment of a technique of improving the identification accuracy of a suspicious location when a failure occurs during execution of a program in an information processing apparatus will be described in detail with reference to the drawings. FIG. 1 illustrates an example of a CPU (central processing unit) and a BMC (baseboard management controller) in an information processing apparatus. The information processing apparatus of FIG. 1 includes a CPU 101 and a BMC 102.

The CPU 101 operates as a log notification unit 111 and a POST code transmission unit 112 by executing a BIOS program when the information processing apparatus is powered on. At booting of the BIOS, the CPU 101 performs a POST by executing a POST program 113 including modules 114-1 to 114-N(N is an integer of 2 or more). As the modules 114-1 to 114-N, for example, the following ones are used.

(a) Memory initialization/test module

(b) CPU initialization/test module

(c) Chipset initialization/test module

(d) Legacy device initialization/test module

(e) Other device initialization/test module

(f) Data construction module

(g) RAS (Reliability Availability Serviceability) function initialization module

The memory initialization/test module is a module that initializes and tests a memory, and the CPU initialization/test module is a module that initializes and tests the CPU 101. The chipset initialization/test module is a module that initializes and tests a chipset. The legacy device initialization/test module is a module that initializes and tests a legacy device, and the other device initialization/test module is a module that initializes and tests other devices.

The data construction module is a module that constructs data such as an ACPI (Advanced Configuration and Power Interface) and an SMBIOS (System Management BIOS) which are used by an OS (Operating System). The RAS function initialization module is a module that initializes the RAS function.

The BMC 102 includes a BIOS log storage area 121, an event log storage area 122, a hang-up detection unit 123, and a POST code storage area 124, manages hardware included in the information processing apparatus, and monitors the operation of the information processing apparatus.

The log notification unit 111 transfers a BIOS log output during the execution of the POST program 113 to the BMC 102 via a serial port, and the BMC 102 stores the received BIOS log in the BIOS log storage area 121. The log notification unit 111 may change the setting of the serial port by changing a setting parameter 115 of the serial port.

When the POST program 113 hangs up due to a certain failure occurring during the execution of the POST program 113, the hang-up detection unit 123 detects a hang-up of the BIOS. Then, the hang-up detection unit 123 stores an event log indicating that the BIOS has hung up, in the event log storage area 122. A maintenance worker or a developer may check the event log stored in the event log storage area 122 through a user interface (UI) provided by the BMC 102, or the like.

The POST code transmission unit 112 transfers a POST code indicating the BIOS booting status to the BMC 102 at a point preset by the developer during the execution of the POST program 113. The POST code is a code indicating how far POST has been performed. In FIG. 1, the POST code is output at the start position of the module 114-i and the module 114-(N−1).

The BMC 102 stores the received POST code in the POST code storage area 124. The POST code in the POST code storage area 124 is updated to the latest POST code as the POST progresses, and is used by the maintenance worker or the developer to identify a rough suspicious range when the BIOS is not normally booted due to failure occurrence.

For example, it is assumed that the BIOS hangs up while the POST code of the module 114-i remains in the POST code storage area 124. In this case, it may be seen that the POST code of the module 114-i has been successfully transmitted, but the POST code of the module 114-(N−1) has not been successfully transmitted. Therefore, it may be seen that the BIOS hangs up between the start of the execution of the module 114-i and the start of the execution of the module 114-(N−1).

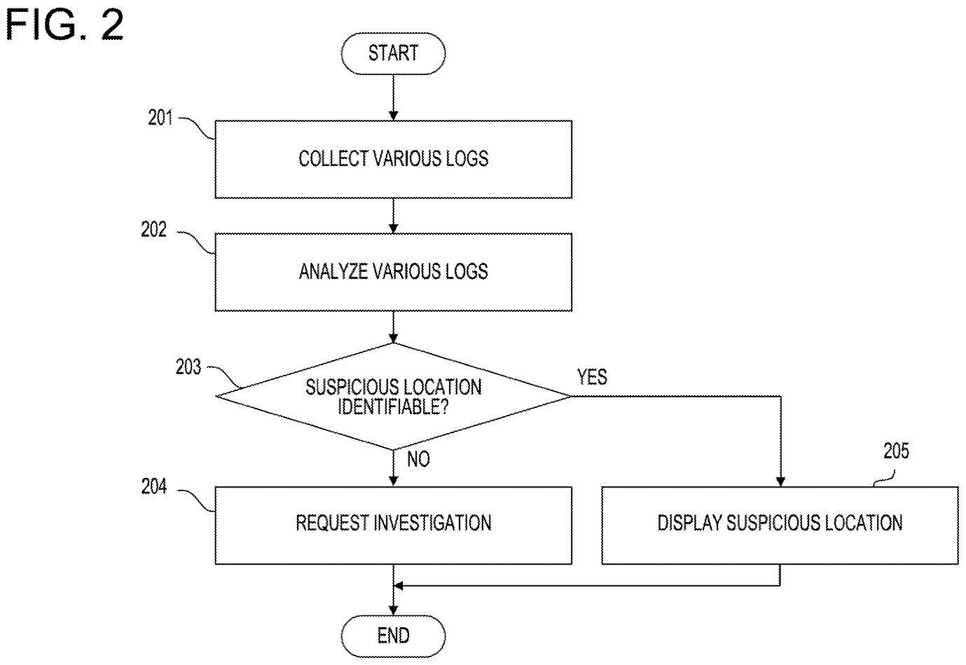

FIG. 2 is a flowchart illustrating an example of suspicious location identification work performed by a maintenance worker when hang-up of the BIOS is detected in the information processing apparatus of FIG. 1. First, the maintenance worker collects various logs of the information processing apparatus in which a failure has occurred (operation 201). The collected various logs include a BIOS log and an event log.

Next, the maintenance worker analyzes the various logs using a log analysis tool (operation 202), and determines whether a suspicious location may be identified by the log analysis tool (operation 203). When it is determined that the suspicious location may be identified (“YES” in operation 203), the maintenance worker displays the suspicious location using the log analysis tool (operation 205). In the meantime, when it is determined that the suspicious location may not be identified (“NO” in operation 203), the maintenance worker requests a developer of a development department to investigate (operation 204)

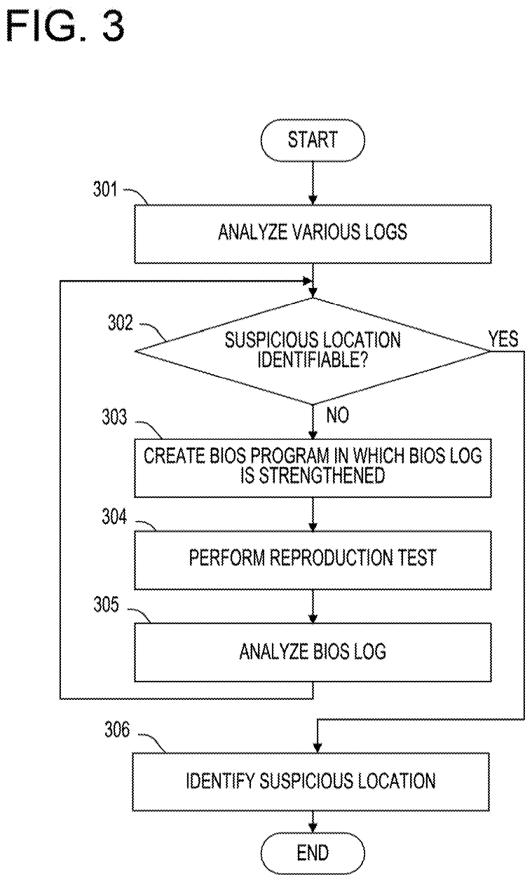

FIG. 3 is a flowchart illustrating an example of investigation operation performed by the developer. First, the developer manually analyzes the various logs collected by the maintenance worker (operation 301), and determines whether a suspicious location may be identified (operation 302). The developer determines that the suspicious location may be identified when the amount of information of log is sufficient, and determines that the suspicious location may not be identified when the amount of information of log is insufficient. When the suspicious location may be identified (“YES” in operation 302), the developer identifies the suspicious location (operation 306).

In the meantime, when the suspicious location may not be identified (“NO” in operation 302), the developer creates a BIOS program in which the BIOS log is enhanced to identify the suspicious location (operation 303). In this case, the developer may enhance the BIOS log by increasing the level of detail of the BIOS log and increasing the amount of information.

Next, the developer performs a reproduction test by causing the information processing apparatus to execute the BIOS program in which the BIOS log is enhanced, and collects the enhanced BIOS log (operation 304). Then, the developer manually analyzes the enhanced BIOS log (operation 305), and repeats the operations after operation 302. The operations of operation 302 to operation 305 are repeated until a suspicious location is identified.

Meanwhile, since the initialization of a high-speed device such as a USB (Universal Serial Bus) port is not completed when the BIOS is booted, the BIOS log is often output via a serial port. The transfer rate of the serial port is about 100 kbps, and the instruction execution speed of the CPU represented by a clock frequency of about several GHz is tens of thousands times higher than the transfer speed of the serial port.

Therefore, the booting time of the BIOS depends on the time for which the BIOS log is transferred to the BMC via the serial port, and becomes longer in proportion to the information amount of the BIOS log to be output. Therefore, the BIOS is designed to output only the minimum BIOS log.

However, when the BIOS hangs up, there may be a case where the suspicious location may not be identified due to the lack of the BIOS log only with the minimum BIOS log. In addition, for example, even when it is possible to identify a suspicious location up to a module from the minimum BIOS log, since the amount of information of BIOS log is not sufficient, it may not be identified which component related to a specified module is the cause, which may result in low accuracy of identification of the suspicious location. In this case, in order to clarify the root cause, the developer often creates the BIOS in which a BIOS log for identifying a suspicious location is enhanced, and performs a reproduction test.

The POST program 113 executed at the time of booting of the BIOS includes other device initialization/test modules. Examples of the other device initialization/test modules may include a PCI (Peripheral Component Interconnect) Bus Scan module which initializes and tests a PCI card. In the PCI Bus Scan module, the amount of information of BIOS log is previously adjusted to an initial value of a predetermined amount so that a large amount of BIOS log is not output.

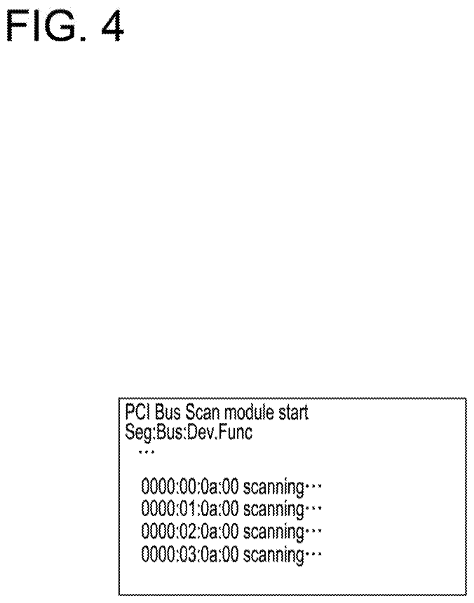

FIG. 4 illustrates an example of a BIOS log that is output when the BIOS hangs up during execution of the PCI Bus Scan module due to a failure of a PCI card or failure of a PCI slot on which the PCI card is mounted. A log analysis tool may analyze the BIOS log of FIG. 4 according to the following procedure to narrow down the suspicious location to a mounting location of the PCI card that is the cause of the failure.

(P1) The log analysis tool identifies, from the collected BIOS log, a part that has hung up during execution of the PCI Bus Scan module.

In the example of FIG. 4, the identification information of a PCI device to be scanned is output in the format of “XXXX:XX:XX:XX scanning . . . ”. When a hang-up occurs during the scan of the PCI device, since the subsequent BIOS logs are not output, the BIOS log output last indicates the hang-up part.

(P2) The log analysis tool acquires the identification information of the PCI device from the BIOS log output last.

Information “Segment:0000, Bus:03, Device:0a, Function:00” is acquired as the identification information of the PCI device from the BIOS log on the last row of FIG. 4.

(P3) The log analysis tool collates the acquired identification information of the PCI device with the configuration information of the information processing apparatus to narrow down the suspicious locations.

By collating the information “Segment:0000, Bus:03, Device:0a, Function:00” with the configuration information of the information processing apparatus, a mounting location of the PCI card which is the cause of the failure occurrence is identified.

However, in this method, even when the PCI card mounting location is identified, it is difficult to determine whether the PCI card itself is faulty or the PCI slot on which the PCI card is mounted is faulty, which may result in low accuracy of identification of the suspicious location. In order to identify whether the suspicious location is a PCI card or a PCI slot, it is desirable to refer to information stored in the register of each of the PCI card and the PCI slot (register information).

When the amount of information is increased by adding register information to the BIOS log, it is possible to identify whether the suspicious location is the PCI card or the PCI slot, which improves the accuracy of identification of the suspicious location. However, as the amount of information in the BIOS log is increased, the BIOS booting time becomes longer.

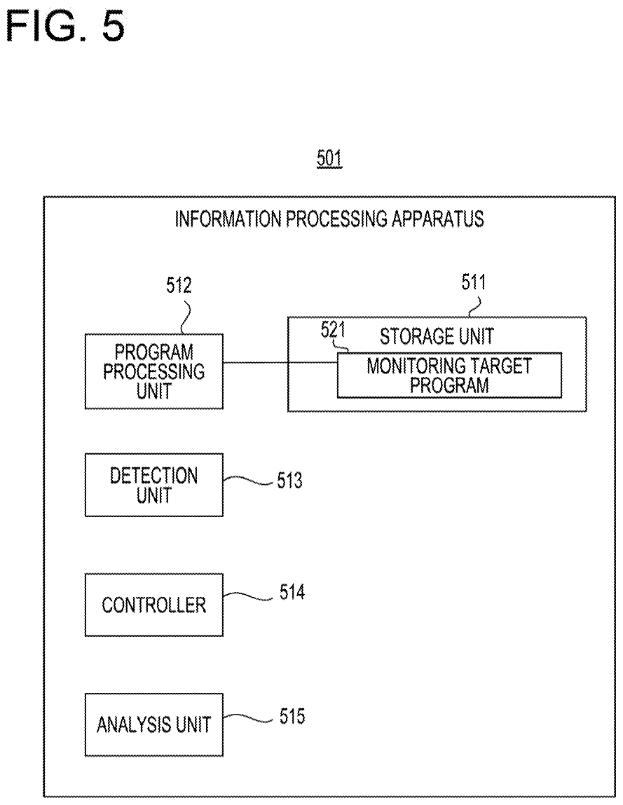

FIG. 5 illustrates a functional configuration example of the information processing apparatus according to the embodiment. The information processing apparatus 501 of FIG. 5 includes a storage unit 511, a program processing unit 512, a detection unit 513, a controller 514, and an analysis unit 515. The storage unit 511 stores a monitoring target program (monitor program) 521, and the program processing unit 512 executes the monitoring target program 521.

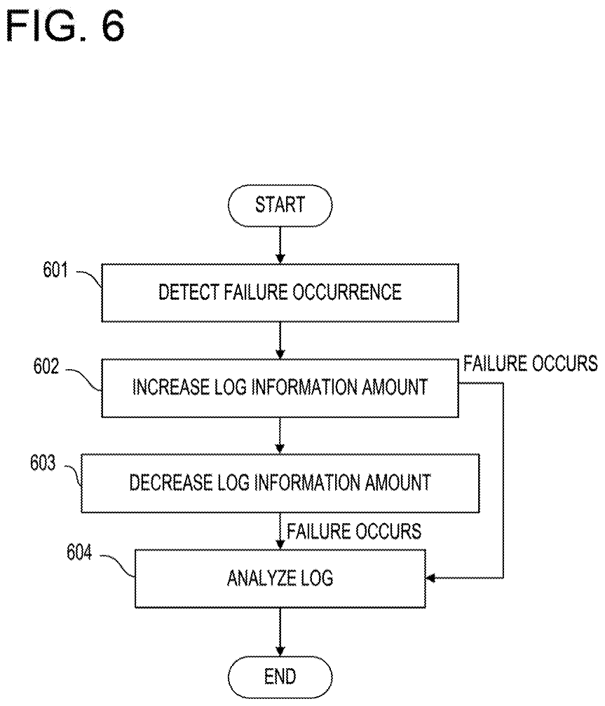

FIG. 6 is a flowchart illustrating an example of a control process performed by the information processing apparatus 501 of FIG. 5. First, the detection unit 513 detects the occurrence of a failure during execution of the monitoring target program 521 (operation 601). When the detection unit 513 detects the occurrence of a failure, the controller 514 sets the amount of information of log output during execution of the monitoring target program 521 to a second setting value which is larger than a first setting value set before the detection of the failure occurrence, and instructs the program processing unit 512 to re-execute the monitoring target program 521 (operation 602).

When the detection unit 513 detects the occurrence of a failure while the program processing unit 512 re-executes the monitoring target program 521 in which the amount of information of log is set to the second setting value, the analysis unit 515 analyzes a log output from the monitoring target program 521 (operation 604).

When the occurrence of a failure is not detected by the execution timing of the monitoring target program 521 while the program processing unit 512 re-executes the monitoring target program 521 in which the information amount of log is set to the second setting value, the controller 514 sets the amount of information of log to a third setting value which is smaller than the second setting value (operation 603). Then, the controller 514 instructs the program processing unit 512 to re-execute the monitoring target program 521.

When the detection unit 513 detects the occurrence of a failure while the program processing unit 512 re-executes the monitoring target program 521 in which the amount of information of log is set to the third setting value, the analysis unit 515 analyzes a log output from the monitoring target program 521 (operation 604).

According to the information processing apparatus 501 of FIG. 5, when a failure occurs during execution of a program in the information processing apparatus, it is possible to improve the accuracy of identification of the suspicious location.

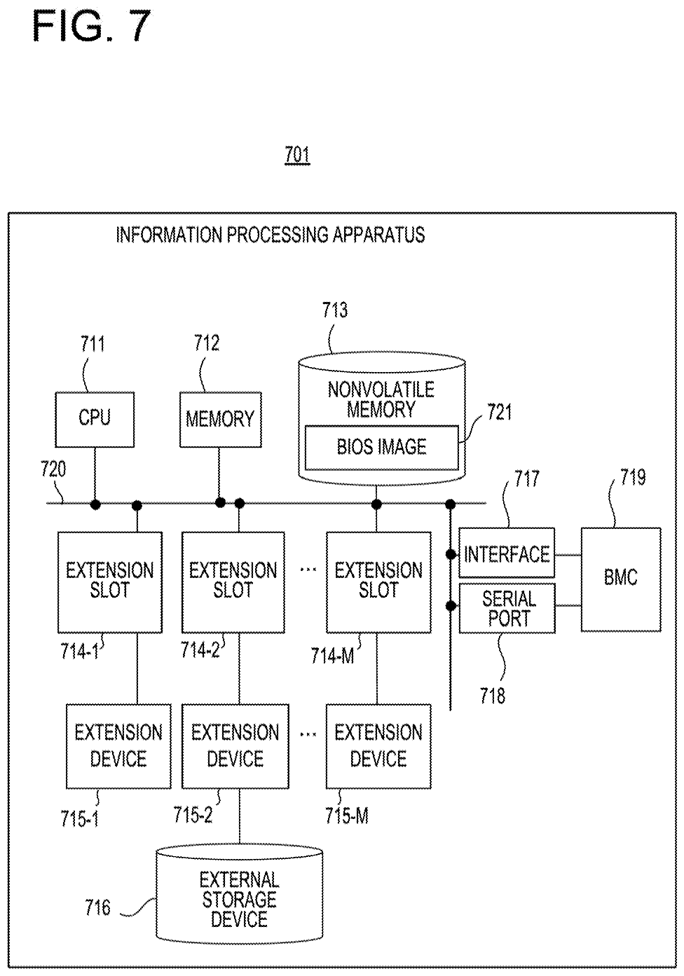

FIG. 7 illustrates an example of the hardware configuration of the information processing apparatus 501 of FIG. 4. The information processing apparatus 701 of FIG. 7 includes a CPU 711 (processor), a memory 712, a nonvolatile memory 713, extension slots 714-1 to 714-M (M is an integer of 2 or more), an interface 717, and a serial port 718. These components are interconnected by a bus 720. Further, the information processing device 701 includes extension devices 715-1 to 715-M, an external storage device 716, and a BMC 719.

The extension devices 715-1 to 715-M are, for example, extension cards, and are mounted in the extension slots 714-1 to 714-M, respectively. The external storage device 716 is connected to the extension device 715-2. The BMC 719 is connected to the interface 717 and the serial port 718.

The memory 712 is, for example, a semiconductor memory such as a RAM (Random Access Memory). The nonvolatile memory 713 corresponds to the storage unit 511 in FIG. 5 and is a semiconductor memory such as a ROM (Read Only Memory) or a flash memory. The nonvolatile memory 713 stores a BIOS image 721 including a BIOS program. The CPU 711 operates as the program processing unit 512 and executes the BIOS program.

The extension devices 715-j (j=1, 3 to M) are a video card, a sound card, a network interface, a storage interface, and the like. The external storage device 716 is, for example, a magnetic disk device, an optical disk device, a magneto-optical disk device, a tape device, or the like. The external storage device 716 may be a hard disk drive. The memory 712, the nonvolatile memory 713, and the external storage device 716 are computer-readable and physical (non-transitory) recording media.

The BMC 719 is a control device that manages hardware included in the information processing apparatus 701 and monitors the operation of the information processing apparatus 701. The hardware included in the information processing apparatus 701 corresponds to, for example, a system board of a server or the like. The interface 717 and the serial port 718 are communication interfaces, and the CPU 711 communicates with the BMC 719 via the interface 717 and the serial port 718.

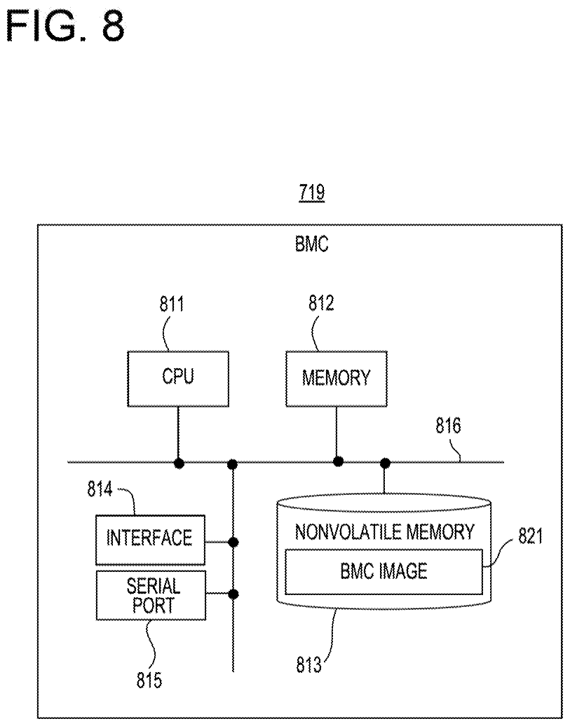

FIG. 8 illustrates an example of the hardware configuration of the BMC 719 of FIG. 7. The BMC 719 in FIG. 8 is a computer that monitors the operation of the information processing apparatus 701, and includes a CPU 811, a memory 812, a nonvolatile memory 813, an interface 814, and a serial port 815. These components are interconnected by a bus 816.

The memory 812 is, for example, a semiconductor memory such as a RAM. The nonvolatile memory 813 is a semiconductor memory such as a ROM, a flash memory, or the like, and stores a BMC image 821 including a BMC program. The CPU 811 operates as the detection unit 513, the controller 514, and the analysis unit 515 in FIG. 5 by executing the BMC program. The memory 812 and the nonvolatile memory 813 are computer-readable and physical (non-transitory) recording media.

The interface 814 and the serial port 815 are communication interfaces, and the CPU 811 communicates with the CPU 711 via the interface 814 and the serial port 815.

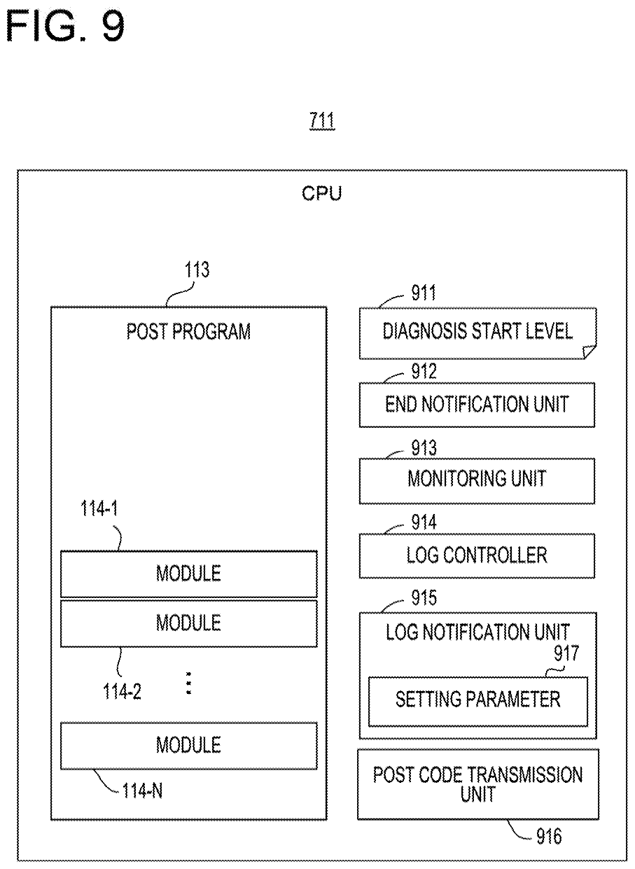

FIG. 9 illustrates an example of the functional configuration of the CPU 711 of FIG. 7. The CPU 711 in FIG. 9 operates as an end notification unit 912, a monitoring unit 913, a log controller 914, a log notification unit 915, and a POST code transmission unit 916 by executing the BIOS program when the information processing apparatus is powered on. At the time of BIOS booting, the CPU 711 performs a POST by executing a POST program 113 including modules 114-1 to 114-N. The POST program 113 corresponds to the monitoring target program 521 in FIG. 5 and is included in the BIOS image 721 in FIG. 7.

When a hang-up of the BIOS is detected during execution of the POST program 113, the BIOS is rebooted by the BMC 719, and the BIOS and the BMC 719 perform a diagnosis process to identify a suspicious location of failure occurrence. In the diagnosis process, the information amount of BIOS log output from each module 114-i (i=1 to N) is changed and the POST program 113 is re-executed.

A diagnosis start level 911 is an index indicating the amount of information of BIOS log output from each module 114-i in the diagnosis process. The diagnosis start level 911 is stored, for example, in the nonvolatile memory 713 of FIG. 7. The CPU 711 adjusts the amount of information of BIOS log output from each module 114-i by referring to the diagnosis start level 911 at the time of execution of each module 114-i.

When the diagnosis process is normally ended, the end notification unit 912 notifies the BMC 719 of the normal end via the interface 717. The monitoring unit 913 monitors the execution status of each module 114-i while the POST program 113 is being executed, and sets the diagnosis start level 911.

The log controller 914 performs a process of thinning out the BIOS log output during the execution of the POST program 113 according to the information acquired from the BMC 719. The log notification unit 915 transfers the BIOS log output during the execution of the POST program 113 to the BMC 719 via the serial port 718. The log notification unit 915 may change the setting of the serial port 718 by changing a setting parameter 917. The POST code transmission unit 916 transfers a POST code to the BMC 719 via the interface 717 at a preset location during the execution of the POST program 113.

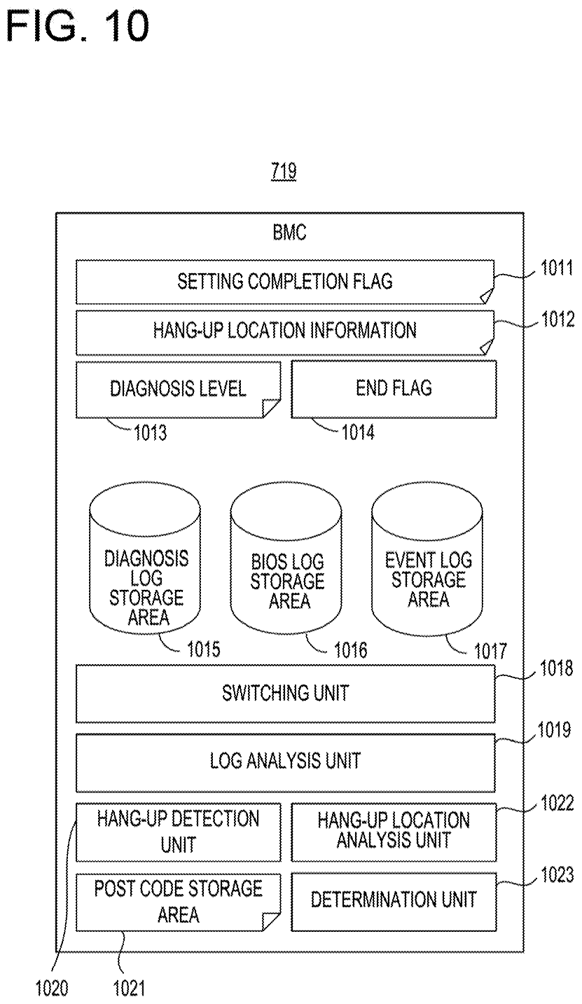

FIG. 10 illustrates an example of the functional configuration of the BMC 719 of FIG. 8. The BMC 719 in FIG. 10 stores a setting completion flag 1011, hang-up location information 1012, a diagnosis level 1013, and an end flag 1014. These pieces of information are stored, for example, in the nonvolatile memory 813 of FIG. 8.

The setting completion flag 1011 indicates whether the setting parameter 917 in FIG. 9 has been changed. When the setting parameter 917 has been changed, the setting completion flag 1011 is set to logic “1”. When the setting parameter 917 has not been changed, the setting completion flag 1011 is set to logic “0”.

The hang-up location information 1012 indicates a failure occurrence location of the POST program 113 when a BIOS hang-up is detected. An example of the hang-up location information 1012 may include identification information of the module 114-I, a POST code, or the like when the BIOS hang-up is detected.

The diagnosis level 1013 is an index indicating a setting value of the information amount of BIOS log output from each module 114-i in the diagnosis process. For example, an integer in the range of 0 to “MAX” is used as the diagnosis level 1013. The symbol “MAX” indicates an integer of 1 or more and represents the maximum value of the diagnosis level 1013. At normal booting of the BIOS, the diagnosis level 1013 is set to 0, which is an initial value.

As the value of the diagnosis level 1013 becomes larger, the level of detail of the BIOS log becomes higher and the amount of information increases. For example, when the diagnosis level 1013 is 0, a BIOS log of the amount of information of an initial value is output. When the diagnosis level 1013 is 1 or more, a BIOS log more detailed than the initial value is output. The level of detail of the BIOS log may be enhanced by including the register information acquired from the register of each component in the information processing apparatus 701 in the BIOS log or increasing the number of register information.

For example, the amount of information of BIOS log with the diagnosis level 1013 of 0 corresponds to the first setting value, the amount of information of BIOS log with the diagnosis level 1013 of MAX corresponds to the second setting value, and the amount of information of BIOS log with the diagnosis level 1013 of 1 to MAX−1 corresponds to the third setting value.

The module 114-i in FIG. 9 may be a module that executes a test of the extension device 715-j mounted on the extension slot 714-j. In this case, the BIOS log with the diagnosis level 1013 of MAX includes the register information acquired from the register of the extension device 715-j and the register information acquired from the register of the extension slot 714-j. When the extension device 715-j is a PCI card, the extension slot 714-j is a PCI slot.

For example, at normal booting of the BIOS, during execution of the PCI Bus Scan module included in the POST program 113, the BIOS log as illustrated in FIG. 4 is output as a BIOS log with the diagnosis level 1013 of 0.

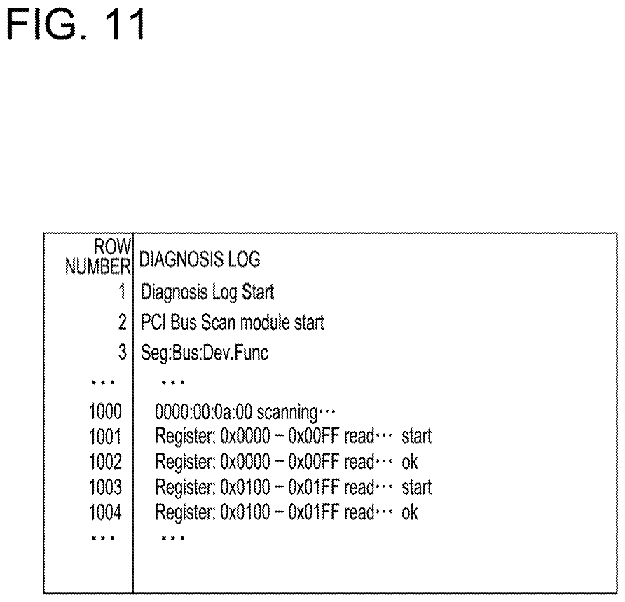

FIG. 11 illustrates an example of a BIOS log with the diagnosis level 1013 of 1, which is output during execution of the PCI Bus Scan module when the BIOS is normally booted in the diagnosis process. Information of row number “1000” represents the identification information of a PCI device contained in the BIOS log of FIG. 4. Information of row numbers “1001” to “1004” represents the identification information of a register to be scanned regarding the PCI device, and is not included in the BIOS log of FIG. 4.

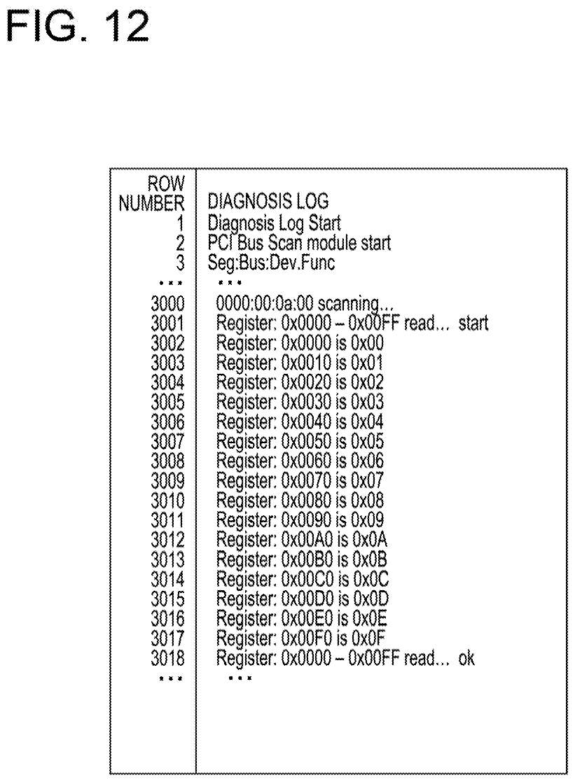

FIG. 12 illustrates an example of a BIOS log with the diagnosis level 1013 of MAX, which is output during execution of the PCI Bus Scan module when the BIOS is normally booted in the diagnosis process. Information of row number “3000” represents the identification information of a PCI device contained in the BIOS log of FIGS. 4 and 11. Information of row numbers “3001” and “3018” is the same as the information of row numbers “1001” and “1002” in FIG. 11, respectively. Information of row numbers “3002” to “3017” represents the register information stored in each register to be scanned and is not included in the BIOS log of FIG. 11.

In this manner, as the value of the diagnosis level 1013 becomes larger, the amount of information may increase by increasing the type of information included in the BIOS log by adding register identification information or adding the register information stored in the register.

In addition, the developer may determine the kind of information to be included in each of the BIOS logs with the diagnosis levels 1013 of 0 to MAX. For example, as the value of the diagnosis level 1013 becomes larger, the number of registers to be acquired for acquiring register information among the registers included in each component may be increased. In addition, for only a specified component, as the value of the diagnosis level 1013 becomes larger, the number of registers to be acquired may be increased.

When a hang-up of the BIOS is detected, the register information up to one of the row numbers “3002” to “3017” in FIG. 12 may be output. In this case, it is possible to identify whether the suspicious location is a PCI card or a PCI slot by analyzing the register information that is being output.

In addition, when the BIOS hangs up due to an unexpected value stored in the register, the cause may be removed by replacing the PCI card or the PCI slot, but there may be a problem with the BIOS itself. In this case, by analyzing the BIOS log including the register information, since the failure occurrence location and the cause of the failure occurrence may be identified more accurately, it is possible to determine the necessity of BIOS correction.

The diagnosis level 1013 is set as the diagnosis start level 911 in FIG. 9 at the start of the diagnosis process. The end flag 1014 indicates whether the BIOS has been normally booted. When the BIOS has been normally booted, the end flag 1014 is set to logic “1”. When the BIOS has not been normally booted, the end flag 1014 is set to logic “0”.

The BMC 719 includes a diagnosis log storage area 1015, a BIOS log storage area 1016, an event log storage area 1017, and a POST code storage area 1021. These storage areas are formed in, for example, the memory 812 in FIG. 8.

The diagnosis log storage area 1015 and the BIOS log storage area 1016 store BIOS logs received from the log notification unit 915 in FIG. 9. The diagnosis log storage area 1015 stores a BIOS log with the diagnosis level 1013 of 1 or more as a diagnosis log, and the BIOS log storage area 1016 stores a BIOS log with the diagnosis level 1013 of 0. The event log storage area 1017 stores an event log, and the POST code storage area 1021 stores a POST code received from the POST code transmission unit 916.

The CPU 811 operates as a switching unit 1018, a log analysis unit 1019, a hang-up detection unit 1020, a hang-up location analysis unit 1022, and a determination unit 1023 by executing a BMC program. The hang-up detection unit 1020 and the log analysis unit 1019 correspond to the detection unit 513 and the analysis unit 515 in FIG. 5, respectively, and the switching unit 1018, the hang-up location analysis unit 1022, and the determination unit 1023 correspond to the controller 514.

When the POST program 113 hangs up, the hang-up detection unit 1020 detects hang-up of the BIOS, and stores an event log indicating that the BIOS has hung up, in the event log storage area 1017.

For example, the hang-up detection unit 1020 has a function of a watchdog timer, and the BIOS sets a predetermined time in the watchdog timer and causes the watchdog timer to start counting at the start of POST. Then, the BIOS periodically resets the watchdog timer during execution of the POST. Even when a predetermined time has elapsed after the watchdog timer was last reset, when the watchdog timer is not reset, the watchdog timer times out. Therefore, the hang-up detection unit 1020 may detect hang-up of the BIOS by detecting the timeout of the watchdog timer.

The hang-up location analysis unit 1022 analyzes the BIOS log stored in the BIOS log storage area 1016 to identify a failure occurrence location, and generates hang-up location information 1012 indicating the identified failure occurrence location.

When the hang-up of the BIOS is detected, the determination unit 1023 determines whether the detected hang-up is a hang-up that occurs during the normal booting of the BIOS or a hang up that recurs during the diagnosis process. In the meantime, when the hang-up of the BIOS is not detected, the determination unit 1023 determines whether the BIOS has been normally booted, based on the end flag 1014.

When a hang-up is detected during the normal booting of the BIOS, the switching unit 1018 changes the setting value of the amount of information of BIOS log by changing the diagnosis level 1013 from 0 to MAX, and instructs the CPU 711 to reboot the BIOS.

When a hang-up is not detected during the rebooting of the BIOS when the diagnosis level 1013 is MAX, the switching unit 1018 gradually increases the amount of information of BIOS log by decrementing the diagnosis level 1013 by one from MAX to 1. Then, the switching unit 1018 instructs the CPU 711 to reboot the BIOS at each stage where the diagnosis level 1013 is set to a value in the range of MAX−1 to 1.

When a hang-up is detected during the rebooting of the BIOS in a state where the diagnosis level 1013 is set to any value of MAX to 1, the log analysis unit 1019 identifies a suspicious location by analyzing the diagnosis log stored in the diagnosis log storage area 1015.

According to the information processing apparatus 701 of FIG. 7, when a hang-up is detected at the time of booting of the BIOS, the BIOS is rebooted by the BMC 719, and the BIOS and the BMC 719 cooperate with each other to perform the diagnosis process, thereby attempting to reproduce the failure.

In the diagnosis process, first, the amount of information of the BIOS log is set to the maximum, and the most detailed BIOS log is collected. At this time, even when the first failure is not reproduced due to a timing failure, the operation of the information processing apparatus 701 approaches the operation at the time of failure occurrence by repeating the rebooting while gradually decreasing the amount of information of the BIOS log. Therefore, the failure is reproduced at any stage, and the BIOS log more detailed than that at the time of first booting is collected, which makes it possible to identify a suspicious location with high accuracy.

In addition, by analyzing the detailed BIOS log by the BMC 719, it is possible to automatically identify a suspicious location without intervention of a maintenance worker or a developer.

A part or all of the end notification unit 912, the monitoring unit 913, and the log controller 914 in FIG. 9 may be mounted on the BMC 719. In this case, the CPU 811 operates as the end notification unit 912, the monitoring unit 913, and the log controller 914 by executing the BMC program.

Further, a part or all of the switching unit 1018, the log analysis unit 1019, the hang-up location analysis unit 1022, and the determination unit 1023 in FIG. 10 may be mounted on the CPU 711. In this case, the CPU 711 operates as the switching unit 1018, the log analysis unit 1019, the hang-up location analysis unit 1022, and the determination unit 1023 by executing the BIOS program.

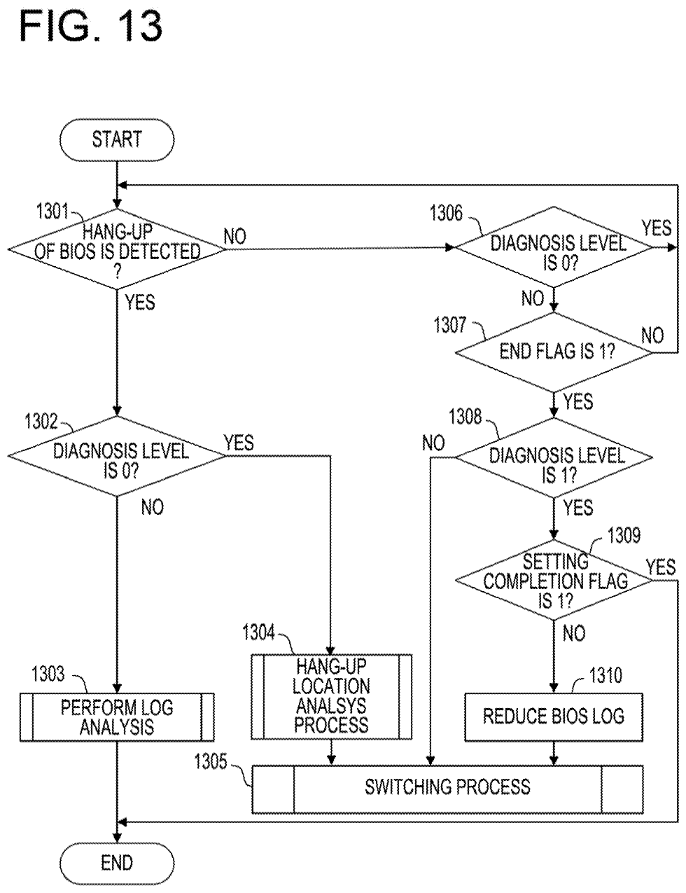

FIG. 13 is a flowchart illustrating an example of a switching control process performed by the BMC 719 in FIG. 10. First, the hang-up detection unit 1020 checks whether a hang-up of the BIOS has been detected (operation 1301). When a hang-up of the BIOS has been detected (“YES” in operation 1301), the hang-up detection unit 1020 stores an event log indicating that the BIOS has hung up, in the event log storage area 1017. Then, the determination unit 1023 checks the value of the diagnosis level 1013 (operation 1302).

When the diagnosis level 1013 is 0, it is determined that the hang-up occurred during the normal booting of the BIOS. When the diagnosis level 1013 is 1 or more, it is determined that the hang-up recurred during the diagnosis process.

When the diagnosis level 1013 is 0 (“YES” in operation 1302), the hang-up location analysis unit 1022 is activated to perform a hang-up location analysis process (operation 1304), and the switching unit 1018 performs a switching process (operation 1305). In the meantime, when the diagnosis level 1013 is 1 or more (“NO” in operation 1302), the log analysis unit 1019 is activated to perform a log analysis process (operation 1303).

When a hang-up of the BIOS has not been detected (“NO” in operation 1301), the determination unit 1023 checks the value of the diagnosis level 1013 (operation 1306). When the diagnosis level 1013 is 0 (“YES” in operation), the hang-up detection unit 1020 repeats the process of operation 1301.

In the meantime, when the diagnosis level 1013 is 1 or more (“NO” in operation 1306), the determination unit 1023 checks the value of the end flag 1014 (operation 1307). When the end flag 1014 is logic “0” (“NO” in operation 1307), the hang-up detection unit 1020 repeats the process of operation 1301.

In the meantime, when the end flag 1014 is logic “1” (“YES” in operation 1307), the determination unit 1023 determines that the hang-up of the BIOS has not recurred in the diagnosis process. Therefore, the determination unit 1023 checks the value of the diagnosis level 1013 (operation 1308). When the diagnosis level 1013 is 2 or more (“NO” in operation 1308), the switching unit 1018 performs a switching process (operation 1305).

In the meantime, when the diagnosis level 1013 is 1 (“YES” in operation 1308), the determination unit 1023 determines that the amount of information of the BIOS log has reached a predetermined amount by gradual decrease. Therefore, the determination unit 1023 checks the value of the setting completion flag 1011 (operation 1309). When the setting completion flag 1011 is logic “0” (“NO” in operation 1309), the determination unit 1023 instructs the log controller 914 in FIG. 9 to reduce the BIOS log (operation 1310). Then, the switching unit 1018 performs a switching process (operation 1305).

When instructed by the determination unit 1023 to reduce the BIOS log, the log controller 914 reduces the amount of information of the BIOS log output to the serial port 718 by thinning out the BIOS log output during execution of the next POST program 113. For example, the log controller 914 may reduce the amount of information of a log by thinning out a text of the BIOS log so that the text of the BIOS log is output at intervals of K characters (K is an integer of 1 or more).

As a result, since the time for which the BIOS log is transferred to the BMC 719 via the serial port 718 is reduced, the operation of the information processing apparatus 701 approaches the operation at the time of failure occurrence, which leads to a high possibility of reproduction of the failure. When the failure is reproduced, a thinned-out BIOS log is collected.

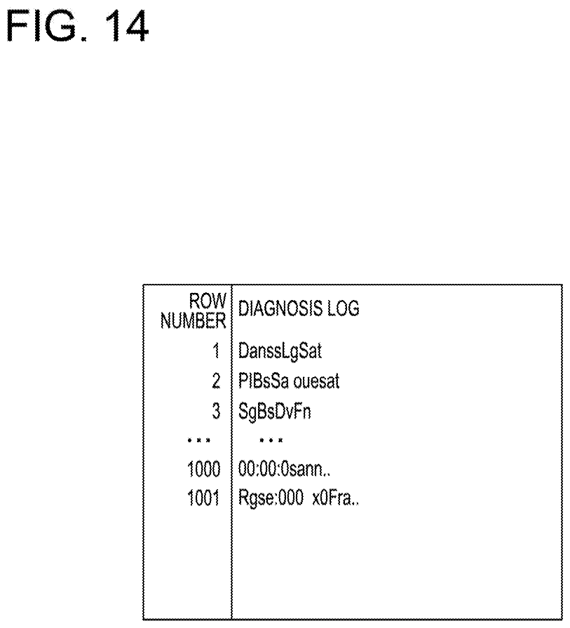

FIG. 14 illustrates an example of the thinned-out BIOS log when the failure is reproduced during execution of the PCI Bus Scan module. Immediately before the setting parameter 917 is changed, the BIOS log with the diagnosis level 1013 of 1 illustrated in FIG. 11 is normally collected.

In FIG. 14, “DanssLgSat” of row number “1” is a text obtained when “Diagnosis Log Start” of row number “1” in FIG. 11 is output every other character. Similarly, texts of row numbers “2”, “3”, “1000”, and “1001” in FIG. 14 are texts obtained when the texts of row numbers “2”, “3”, “1000”, and “1001” in FIG. 11 are output every other character.

The BIOS log in FIG. 14 is interrupted at row number “1001” due to a hang-up of the BIOS. Therefore, by analyzing the BIOS log of FIG. 11 and the BIOS log of FIG. 14 in association, it is possible to acquire more detailed failure information than the BIOS log of FIG. 4, thereby identifying a suspicious location with high accuracy.

When the setting completion flag 1011 is logic “1” (“YES” in operation 1309), the determination unit 1023 determines that the failure is not reproduced even when the BIOS log is thinned out. Therefore, the determination unit 1023 stores an event log indicating that the failure has not been reproduced, in the event log storage area 1017, and ends the process.

In addition, the log controller 914 may repeat the process of thinning out the BIOS log a plurality of times instead of only once. In this case, the text of the BIOS log to be output decreases gradually such as at intervals of K characters, at intervals of (K+1) characters, or at intervals of (K+2) characters. Further, the log controller 914 may adjust the transfer time of the serial port 718 more finely by setting the baud rate of the serial port 718 together.

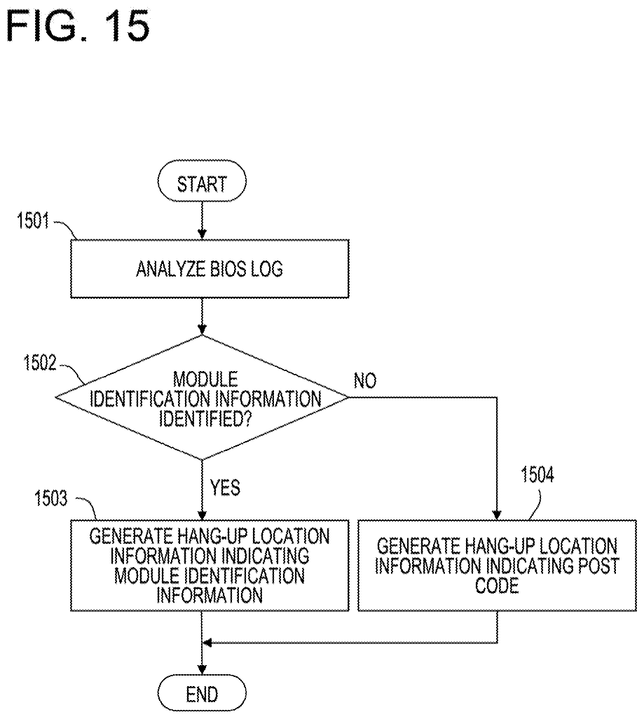

FIG. 15 is a flowchart illustrating an example of the hang-up location analysis process in operation 1304 of FIG. 13. First, the hang-up location analysis unit 1022 analyzes the BIOS log stored in the BIOS log storage area 1016 (operation 1501), and checks whether the identification information of the hung-up module 114-i is identified (operation 1502).

When the identification information of the hung-up module 114-i is identified (“YES” in operation 1502), the hang-up location analysis unit 1022 generates hang-up location information 1012 indicating the identification information of the module 114-i (operation 1503).

In the meantime, when the identification information of the hung-up module 114-i is not identified (“NO” in operation 1502), the hang-up location analysis unit 1022 acquires the POST code stored immediately before the hang-up, from the POST code storage area 1021. Then, the hang-up location analysis unit 1022 generates hang-up location information 1012 indicating the acquired POST code (operation 1504).

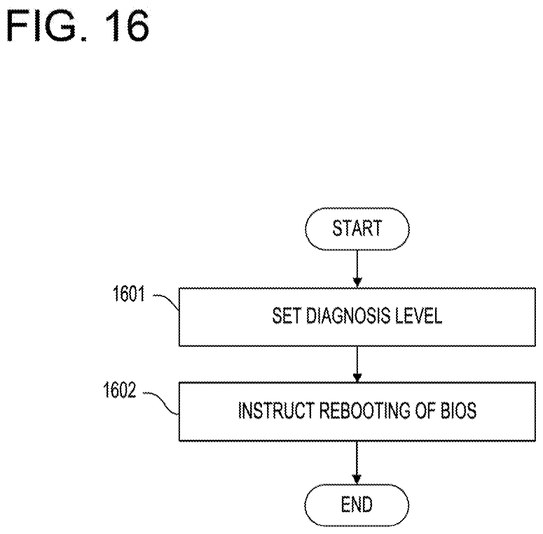

FIG. 16 is a flowchart illustrating an example of the switching process in operation 1305 of FIG. 13. The switching unit 1018 sets the diagnosis level 1013 to any value of MAX to 1 (operation 1601), and instructs the CPU 711 to reboot the BIOS (operation 1602).

When the switching process is performed following the process of operation 1304, the diagnosis level 1013 is changed from 0 to MAX in operation 1601. The value of MAX may be a value common to the modules 114-1 to 114-N, or may be different for each hung-up module 114-i.

When the switching process is performed following the process of operation 1308, the diagnosis level 1013 is decremented by 1 in operation 1601. When the switching process is performed following the process of operation 1310, the diagnosis level 1013 is set to 1 in operation 1601.

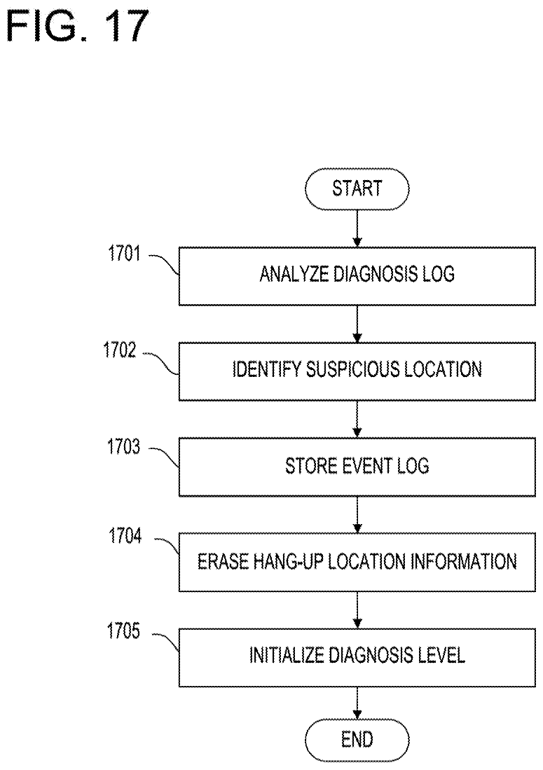

FIG. 17 is a flowchart illustrating an example of the log analysis process in operation 1303 of FIG. 13. First, the log analysis unit 1019 uses an analysis algorithm corresponding to each module 114-i to analyze the diagnosis log stored in the diagnosis log storage area 1015 (operation 1701), and identifies a suspicious location (operation 1702).

Next, the log analysis unit 1019 stores an event log in the event log storage area 1017 (operation 1703). When the suspicious location is identified, an event log indicating that the suspicious location is identified is stored in the event log storage area 1017. When the suspicious location is not identified, an event log indicating that the suspicious location is not identified is stored in the event log storage area 1017.

Next, the log analysis unit 1019 erases the hang-up location information 1012 (operation 1704), and initializes the diagnosis level 1013 by changing the diagnosis level 1013 to 0 (operation 1705).

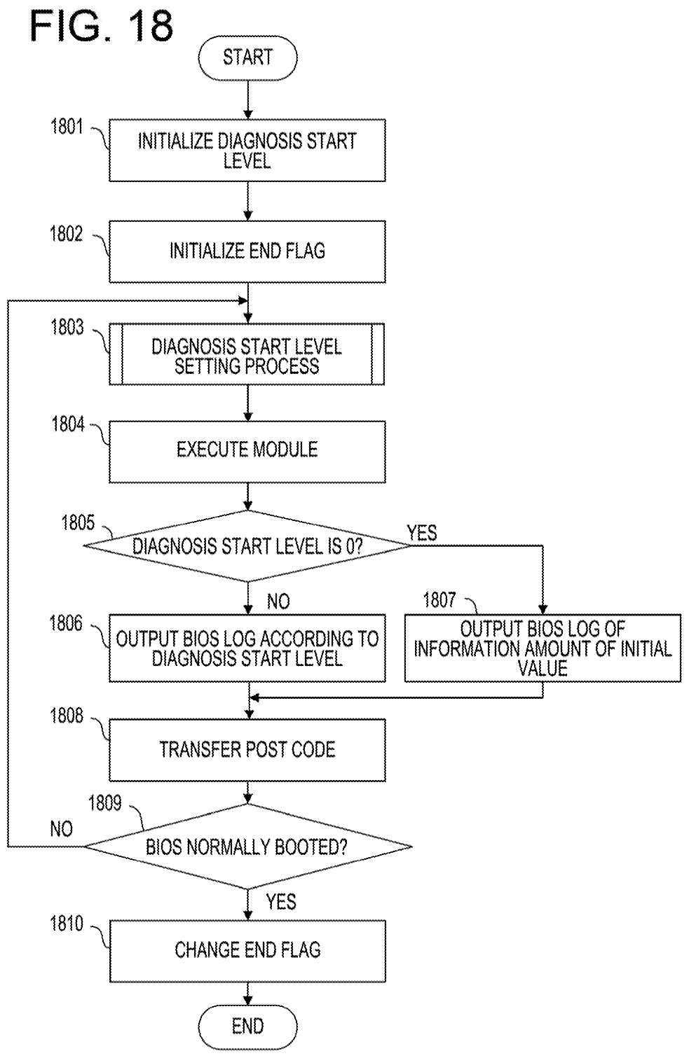

FIG. 18 is a flowchart illustrating an example of the log adjustment process performed by the CPU 711 of FIG. 9. First, the monitoring unit 913 initializes the diagnosis start level 911 by setting the diagnosis start level 911 to (operation 1801). Next, the monitoring unit 913 instructs the BMC 719 to initialize the end flag 1014 (operation 1802), and the determination unit 1023 in FIG. 10 sets the end flag 1014 to logic “0”.

Next, the monitoring unit 913 performs a diagnosis start level setting process (operation 1803), and the CPU 711 executes the module 114-i of the POST program 113 (operation 1804). The modules 114-1 to 114-N are sequentially executed from the module 114-1, and the next module 114-i is executed each time the process of operation 1804 is repeated.

Next, the CPU 711 checks the value of the diagnosis start level 911 (operation 1805). When the diagnosis start level 911 is 0 (“YES” in operation 1805), the CPU 711 causes the executed module 114-i to output the BIOS log of the information amount of the initial value (operation 1807). In this case, the log notification unit 915 transfers the BIOS log with the BIOS diagnosis level 1013 of 0 to the BMC 719 via the serial port 718.

In the meantime, when the diagnosis start level 911 is not 0 (“NO” in operation 1805), the CPU 711 causes the executed module 114-i to output the BIOS log of the information amount according to the diagnosis start level 911 (operation 1806). In this case, the log notification unit 915 transfers the BIOS log with the BIOS diagnosis level 1013 of any of MAX to 1 to the BMC 719 via the serial port 718.

Next, the POST code transmission unit 916 transfers a POST code to the BMC 719 via the interface 717 (operation 1808). Then, the monitoring unit 913 checks whether the BIOS has been booted normally (operation 1809). When the BIOS has not been booted normally (“NO” in operation 1809), the CPU 711 repeats the processes after operation 1803.

When the BIOS has been booted normally (“YES” in operation 1809), the monitoring unit 913 instructs the BMC 719 to change the end flag 1014 (operation 1810), and the determination unit 1023 in FIG. 10 sets the end flag 1014 to logic “1”.

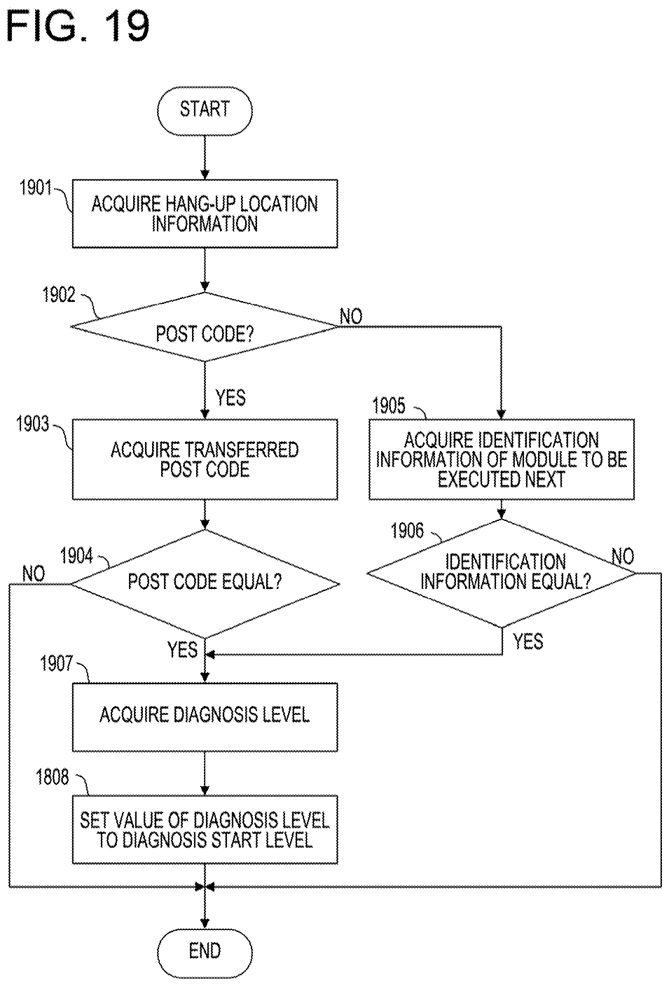

FIG. 19 is a flowchart illustrating an example of the diagnosis start level setting process in operation 1803 of FIG. 18. First, the monitoring unit 913 acquires hang-up location information 1012 from the BMC 719 via the interface 717 (operation 1901), and checks the acquired hang-up location information 1012 (operation 1902).

When the hang-up location information 1012 indicates identification information of any module 114-p (p=1 to N) (“NO” in operation 1902), the monitoring unit 913 acquires identification information of a module 114-i to be executed next (operation 1905). Then, the monitoring unit 913 compares the identification information of the module 114-i with the identification information of the module 114-p (operation 1906).

When the identification information of the module 114-i is equal to the identification information of the module 114-p (“YES” in operation 1906), the monitoring unit 913 acquires the diagnosis level 1013 from the BMC 719 via the interface 717 (operation 1907). Then, the monitoring unit 913 sets the value of the acquired diagnosis level 1013 as the diagnosis start level 911 (operation 1908). In the meantime, when the identification information of the module 114-i is different from the identification information of the module 114-p (“NO” in operation 1906), the monitoring unit 913 ends the process.

When the hang-up location information 1012 indicates the POST code (“YES” in operation 1902), the monitoring unit 913 acquires the POST code last transferred by the POST code transmission unit 916 (operation 1903). Then, the monitoring unit 913 compares the last transferred POST code with the POST code indicated by the hang-up location information 1012 (operation 1904).

When the transferred POST code is equal to the POST code indicated by the hang-up location information 1012 (“YES” in operation 1904), the monitoring unit 913 performs the processes after operation 1907. In the meantime, when the transferred POST code is different from the POST code indicated by the hang-up location information 1012 (“NO” in operation 1904), the monitoring unit 913 ends the process.

According to the diagnosis start level setting process of FIG. 19, the diagnosis start level 911 is changed so that the BIOS log of the information amount indicated by the diagnosis level 1013 is output at the failure occurrence location indicated by the hang-up location information 1012.

For example, when the diagnosis level 1013 is MAX, the CPU 711 adjusts the information amount of the BIOS log output at the failure occurrence location to the information amount with the diagnosis level 1013 of MAX. In addition, when the diagnosis level 1013 is decremented by one from MAX to 1, the CPU 711 adjusts the information amount of the BIOS log output at the failure occurrence location to the information amount with the diagnosis level 1013 of MAX−1 to 1 at each stage. As a result, the information amount of the BIOS log at the failure occurrence location is adjusted in accordance with the diagnosis level 1013.

According to the switching control process of FIG. 13 and the log adjustment process of FIG. 18, when a hang-up is detected at the time of booting of the BIOS, the diagnosis level 1013 and the diagnosis start level 911 are set to MAX and the BIOS is rebooted to perform the reproduction of failure. Then, when the failure is not reproduced, the BIOS rebooting is repeated while decrementing the diagnosis level 1013 and the diagnosis start level 911 by one from MAX to 1. When the failure is not reproduced even when the diagnosis level 1013 and the diagnosis start level 911 are set to 1, a process for thinning out the BIOS log is started after the BIOS is rebooted.

As a result, the amount of information of the BIOS log decreases gradually and the operation of the information processing apparatus 701 approaches the operation at the time of failure occurrence, which increases the possibility of reproduction of the failure. When the failure is reproduced, a more detailed BIOS log than that at the first booting is collected, which makes it possible to identify a suspicious location with high accuracy.

When the thinned-out BIOS log is collected by performing the control of operation 1310 of FIG. 13, the developer analyzes the diagnosis log stored in the diagnosis log storage area 1015.

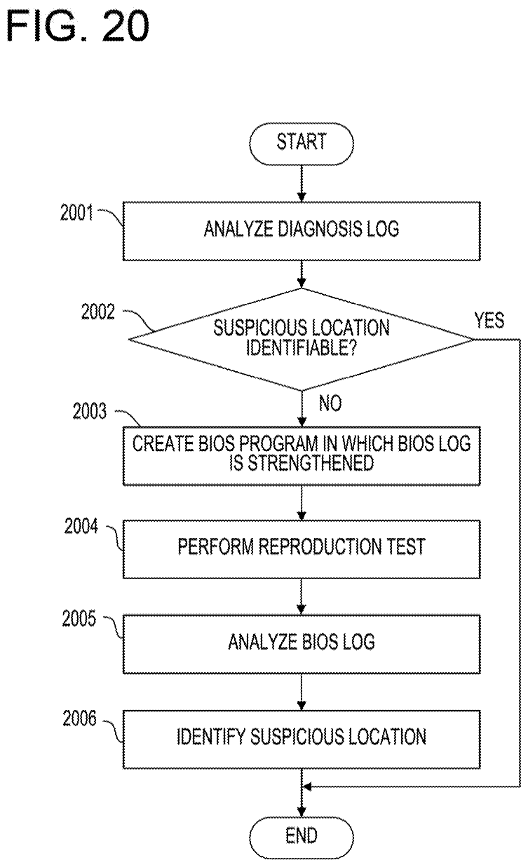

FIG. 20 is a flowchart illustrating an example of analysis operation of analyzing the thinned-out BIOS log. First, the developer manually analyzes the diagnosis log stored in the diagnosis log storage area 1015 (operation 2001), and determines whether a suspicious location may be identified (operation 2002).

At this time, the developer compares the BIOS log with the diagnosis level 1013 of 1 collected when the BIOS is booted normally, with the thinned-out BIOS log collected when the BIOS hangs up. Then, the developer supplements the thinned-out portion by associating these BIOS logs.

As illustrated in FIGS. 11 and 14, since these two BIOS logs are collected in the same hardware configuration, the BIOS log before being thinned out when the BIOS hangs up is almost the same as the BIOS log with the diagnosis level 1013 of 1. Therefore, by associating the two BIOS logs, it is possible to supplement the thinned-out text and identify a suspicious location that is the cause of failure occurrence.

When the suspicious location may be identified (“YES” in operation 2002), the developer ends the analysis operation. In the meantime, when the suspicious location may not be identified (“NO” in operation 2002), the developer creates a BIOS program in which the BIOS log is enhanced (operation 2003).

Next, the developer performs a reproduction test by causing the CPU 711 to execute the BIOS program in which the BIOS log is enhanced, and collects the enhanced BIOS log (operation 2004). Then, the developer manually analyzes the enhanced BIOS log (operation 2005) and identifies a suspicious location (operation 2006).

When the suspicious location may be identified in operation 2002, operations 2003 to 2006 become unnecessary and the analysis operation ends immediately. Even when the suspicious location may not be identified in operation 2002, the suspicious location may be roughly estimated since the more detailed information than the BIOS log with the diagnosis level 1013 of 0 is acquired.

Therefore, by performing the reproduction test in which the BIOS log is enhanced only once, there is a high possibility that the suspicious location may be identified, and it is not necessary to repeat the reproduction test a plurality of times as in the investigation operation of FIG. 3. As a result, it is possible to obtain information useful for the developer in estimating a suspicious location and to shorten the period of analysis operation.

The CPU 101 and the BMC 102 in FIG. 1 are merely examples, and certain components may be omitted or changed depending on the application or conditions of the CPU 101 and the BMC 102.

The configuration of the information processing apparatus illustrated in FIGS. 5 and 7 is merely an example, and certain components may be omitted or changed according to the application or conditions of the information processing apparatus. The configuration of the BMC 719 in FIG. 8 is merely an example, and certain components may be omitted or changed depending on the application or conditions of the information processing apparatus 701.

The configurations of the CPU 711 in FIG. 9 and the BMC 719 in FIG. 10 are merely examples, and certain components may be omitted or changed depending on the application or conditions of the information processing apparatus 701. For example, when the process for thinning out the BIOS log is not performed, the log controller 914 in FIG. 9 may be omitted. The CPU 711 may execute another program including a plurality of modules, instead of the POST program 113, and may transfer a log output during the execution to the BMC 719.

The flowcharts of FIGS. 2, 3, 6, 13, and 15 to 20 are merely examples, and certain operations may be omitted or changed depending on the configuration or conditions of the information processing apparatus. For example, in the switching control process of FIG. 13, when the process for thinning out the BIOS log is not performed, operations 1309 and 1310 may be omitted.

The BIOS logs illustrated in FIGS. 4, 11, 12, and 14 are merely examples, and the BIOS log may be changed depending on the configuration or conditions of the information processing apparatus.

While the disclosed embodiments and the advantages thereof have been described in detail, it should be understood by those skilled in the art that various changes, additions, and omissions may be made without departing from the spirit and scope of the present disclosure as set forth in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory in which a monitor program is stored; and
a processor coupled to the memory and configured to:
execute the monitor program with a first amount of log information to be output during an execution of the monitor program;
detect an occurrence of a failure while the monitor program is being executed with the first amount;
change an amount of the log information from the first amount to a second amount larger than the first amount, when the occurrence of the failure is detected while the monitor program is being executed with the first amount;
execute the monitor program with the second amount;
change the amount of the log information from the second amount to a third amount smaller than the second amount, when the occurrence of the failure is not detected while the monitor program is being executed with the second amount;
execute the monitor program with the third amount; and
analyze the log information, when the occurrence of the failure is detected while the monitor program is being executed with the second amount or executed with the third amount.

2. The information processing apparatus according to claim 1,
wherein the processor is further configured to:
generate information that indicates a failure occurrence location of the monitor program when the occurrence of the failure is detected while the monitor program is being executed with the first amount;
adjust the amount of the log information to be output at the failure occurrence location to the second amount, when the monitor program is executed with the second amount; and
adjust the amount of the log information to be output at the failure occurrence location to the third amount, when the monitor program is executed with the third amount.

3. The information processing apparatus according to claim 1,
wherein the processor is further configured to:
thin out a log output from the monitor program, when the occurrence of the failure is not detected while the monitor program is being executed with the third amount; and
analyze the thinned out log, when the monitor program is being executed with the third amount, when the log is thinned out, and when the occurrence of the failure is detected.

4. The information processing apparatus according to claim 1,
wherein the monitor program is performed by a Basic Input/Output System (BIOS), and
wherein the processor is configured to detect a hang-up of the monitor program as the occurrence of the failure.

5. The information processing apparatus according to claim 4, further comprising:
an extension slot over which an extension device is mounted,
wherein the log information that is output while the monitor program is being executed with the second amount includes information acquired from a register of the extension device and information acquired from a register of the extension slot.

6. A computer-readable non-transitory recording medium having stored therein a program that causes a computer to execute a procedure, the procedure comprising:
executing a monitor program with a first amount of log information to be output during the execution of the monitor program to monitor an operation of an information processing apparatus;
detecting an occurrence of a failure while the monitor program is being executed with the first amount;
changing an amount of the log information from the first amount to a second amount larger than the first amount, when the occurrence of the failure is detected while the monitor program is being executed with the first amount; and
executing the monitor program with the second amount;
changing the amount of the log information from the second amount to a third amount smaller than the second amount, when the occurrence of the failure is not detected while the monitor program is being executed with the second amount;
executing the monitor program with the third amount; and
analyzing the log information, when the occurrence of the failure is detected while the monitor program is being executed with the second amount or executed with the third amount.

7. The computer-readable non-transitory recording medium according to claim 6,
wherein the procedure further:
generates information that indicates a failure occurrence location of the monitor program when the occurrence of the failure is detected while the monitor program is being executed with the first amount;
adjusts the amount of the log information to be output at the failure occurrence location to the second amount, when the monitor program is executed with the second amount; and
adjusts the amount of the log information to be output at the failure occurrence location to the third amount, when the monitor program is executed with the third amount.

8. The computer-readable non-transitory recording medium according to claim 6,
wherein the procedure further:
thins out a log output from the monitor program when the occurrence of the failure is not detected while the monitor program is being executed with the third amount; and
analyzes the thinned out log, when the monitor program is being executed with the third amount, when the log is thinned out, and when the occurrence of the failure is detected.

9. The computer-readable non-transitory recording medium according to claim 6,
wherein the monitor program is performed by a Basic Input/Output System (BIOS), and
wherein the procedure detects a hang-up of the monitor program as the occurrence of the failure.

10. The computer-readable non-transitory recording medium according to claim 9:
wherein the log information that is output while the monitor program is being executed with the second amount includes information acquired from a register of an extension device and information acquired from a register of an extension slot, the extension device mounted over the extension slot included in the information processing apparatus.
